(19) United States
(12) Patent Application Publication
(10) Pub. No.: US 2020/0074371 A1
(43) Pub. Date: Mar. 5, 2020

(54) METHOD FOR MANAGING STOCK WITHIN A STORE

(71) Applicant: Simbe Robotics, Inc., San Francisco, CA (US)

(72) Inventor: Bradley Bogolea, San Francisco, CA (US)

(21) Appl. No.: 16/450,889

(22) Filed: Jun. 24, 2019

Related U.S. Application Data
(60) Provisional application No. 62/689,082, filed on Jun. 23, 2018.

(51) Int. Cl. G06Q 10/06

(52) U.S. Cl. CPC G06Q 10/06315

(57) ABSTRACT

One variation of a method for managing stock within stores includes: dispatching a robotic system to autonomously scan inventory structures within a store during a scan cycle; accessing scan data recorded by the robotic system during the scan cycle; deriving a stock condition of the store based on scan data recorded by the robotic system during the scan cycle; based on the stock condition of the store, detecting a first deviation between a state of a slot in the store and an internal target state of the slot defined by an affiliate of the store; and, based on the stock condition of the store, detecting a second deviation between a second state of a second slot in the store and an external target state of the second slot defined by an external entity affiliated with a second product assigned to the second slot.

### CROSS-REFERENCE TO RELATED APPLICATIONS

This application claims the benefit of U.S. Provisional Application No. 62/689,082, filed on 23 Jun. 2018, which is incorporated in its entirety by this reference.

This application is related to U.S. patent application Ser. No. 15/347,689, filed on 9 Nov. 2016, and to U.S. patent application Ser. No. 15/600,527, filed on 19 May 2017, each of which is incorporated in its entirety by this reference.

### TECHNICAL FIELD

This invention relates generally to the field of inventory management and more specifically to a new and useful method for managing stock within a store in the field of inventory management.

### BRIEF DESCRIPTION OF THE FIGURES

FIG. 1 is a flowchart representation of a method;

FIG. 2 is a flowchart representation of one variation of the method;

FIG. 3 is a schematic representation of one variation of the method; and

FIG. 4 is a schematic representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. METHOD

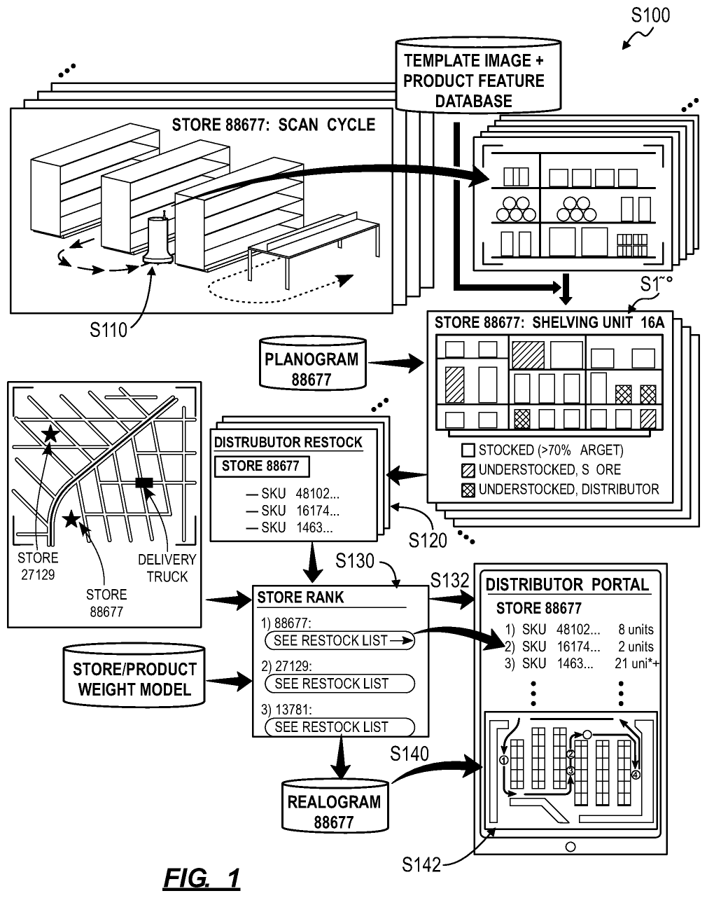

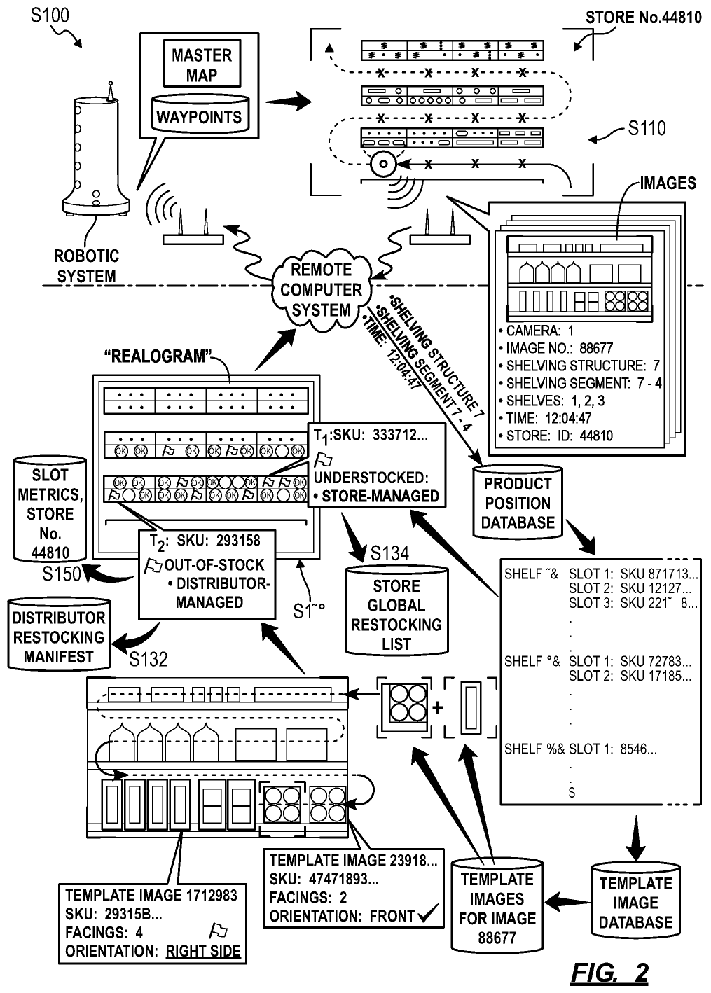

As shown in FIGS. 1 and 2, a method S100 for managing stock within a store includes: for each store in a set of stores within a geographic region: dispatching a robotic system, deployed in the store, to autonomously scan shelving structures within the store during a scan cycle in Block S110; deriving a current stock condition of the store based on scan data recorded by the robotic system during the scan cycle in Block S112; and, based on a difference between the current stock condition and a planogram of the store, identifying a subset of understocked slots in the store designated for management by a distributor external to the store in Block S120. The method S100 also includes: ranking stores, in the set of stores, based on values of subsets of understocked slots in the set of stores in Block S130; based on a rank of a first store in the set of stores, dispatching a distributor associate to the first store to restock a first subset of understocked slots in the first store in Block S132; based on a current stock condition of the first store, calculating a first route through locations of slots in the first subset of slots in the first store in Block S140; and serving the first route to a computing device affiliated with the distributor associate in Block S142.

One variation of the method S100 includes: at a first time, dispatching a first robotic system, deployed in a first store, to autonomously scan inventory structures within the first store during a first scan cycle in Block S110; accessing scan data recorded by the first robotic system during the first scan cycle in Block S112; deriving a first stock condition of the first store at approximately the first time based on scan data recorded by the first robotic system during the first scan cycle in Block S112; based on the first stock condition of the first store, detecting a first deviation between a first state of a first slot in a first inventory structure in the first store at approximately the first time and a internal target stock condition of the first slot defined by an affiliate of the first store in Block S120; in response to detecting the first deviation, serving a first prompt to restock the first slot to an associate of the first store in Block S134; based on the first stock condition of the first store, detecting a second deviation between a second state of a second slot in a second inventory structure in the first store at approximately the first time and an external target stock condition of the second slot defined by an entity external to the first store and affiliated with a second product assigned to the second slot in Block S120; and, in response to detecting the second deviation, serving a second prompt to restock the second slot to a distributor external to the first store in Block S132.

Yet another variation of the method S100 includes: at a first time, dispatching a first robotic system, deployed in a first store, to autonomously scan inventory structures within the first store during a first scan cycle in Block S110; accessing scan data recorded by the first robotic system during the first scan cycle in Block S112; deriving a first stock condition of the first store at approximately the first time based on scan data recorded by the first robotic system during the first scan cycle in Block S112; based on the first stock condition of the first store, detecting a first deviation between a first state of a first slot in a first inventory structure in the first store at approximately the first time and an internal target stock condition of the first slot defined by an affiliate of the first store in Block S120; in response to detecting the first deviation, serving a first prompt to restock the first slot to an associate of the first store in Block S134; and, based on the first stock condition of the first store, detecting a second deviation between a second state of a second slot in a second inventory structure in the first store at approximately the first time and an external target stock condition of the second slot defined by an entity external to the first store and affiliated with a second product assigned to the second slot in Block S120. This variation of the method S100 also includes: at a second time, dispatching a second robotic system to autonomously scan inventory structures within the first store during a second scan cycle in Block S110; accessing scan data recorded by the first robotic system during the second scan cycle in Block S112; deriving a second stock condition of the first store at approximately the second time based on scan data recorded by the first robotic system during the second scan cycle in Block S112; based on the second stock condition of the first store, detecting a third deviation between a second state of the second slot at approximately the second time and the external target stock condition of the second slot in Block S120; and generating a statement of stock states of the second slot based on the second deviation and the third deviation and returning the statement to the entity in Block S150.

### 2. APPLICATIONS

Generally, the method S100 can be executed by a computer system (e.g., a computer network, a remote server): to autonomously derive a current stock condition of a store (e.g., a grocery store, a clothing store) via mobile and/or fixed sensors deployed in the store; to compare this current stock condition to a planogram or other representation of a target stock condition of the store to identify a set of slots in the store that are currently understocked or out-of-stock; to isolate a subset of these understocked or out-of-stock slots that are designated for management by a distributor (or a brand, a consumer goods company, another external entity); and to selectively prompt the distributor to return to the store to restock this subset of slots while concurrently generating and distributing real-time or grouped prompts to store associates to maintain stock conditions of other slots in the store designated for internal management by the store.

In particular, the computer system can interface with a mobile robotic system deployed in a store to collect scans of inventory structures (e.g., shelving structures and other product displays) within the store and to extract a high-resolution stock condition of the store from these scans, such as once per day, once per hour, or continuously while the store is in operation. In particular, by dispatching the robotic system to scan inventory structures throughout the store during a scan cycle and deriving stock states of many (or all) slots in these inventory structures based on scan data recorded by the robotic system, the computer system can construct an accurate representation of the real stock condition of the store at the current time based on direct inventory measurements of slots throughout the store, such as rather than rely on point-of-sale data to predict the stock condition of the store, which may fail to account for damaged product, stolen product, and slot origins of product sold at the store.

The computer system can then leverage the current stock condition of the store to identify out-of-stock or understocked slots contracted for restocking and management by an external entity (e.g., a consumer goods company or soft-drink manufacturer), such as based on deviation of the states of these slots from a target condition specified in an external planogram or contract defined by the external entity for this store. Responsive to detecting such out-of-stock or understock conditions for slots in the store managed by the external entity, the computer system can execute Blocks of the method S100 to: automatically communication to a distributor affiliated with the external entity (or the external entity directly); when these slots in the store managed by the distributor are understocked or out-of-stock; specific quantities of products to deliver to the store in order to return these slots to their target states specified in the external planogram or contract; and/or specific locations of slots in the store necessitating restocking by the distributor.

The computer system can therefore execute Blocks of the method S100 to monitor select slots—managed by an external entity or its distributor (e.g., a local or regional distributor)—in the store on behalf of the external entity or distributor not regularly present in the store based on scan data recorded by a mobile sensor (and/or fixed sensors) deployed to the store. Accordingly, the computer system can generate and return selective guidance to the distributor (or external entity) regarding which products to restock, how many units of these products to restock, locations of slots necessitating restocking, and timing for restocking events at the store, thereby enabling the distributor (or external entity) to improve resource allocation and efficiency for maintaining these slots in the store despite the distributor's lack of consistent presence in the store.

The computer system can implement similar methods and techniques to monitor states of slots—also managed by the distributor—in other stores and to selectively prompt the distributor to return to these stores and restock select slots designated for management by the distributor (or by the external entity more generally). Furthermore, the computer system can prioritize or rank these stores based on stock states and product characteristics of these slots, such as: projected product sale rate; product margins; store and distributor associate locations; quantities of understocked and out-of-stock slots, managed by the distributor, in these stores; and/or current customer traffic in these stores; etc. The computer system can then prompt the distributor to dispatch distributor associates to all or a subset of these stores for targeted restocking of its products according to these store rankings. The computer system can also: calculate a vehicle route that maximizes efficiency of a distributor associate making product deliveries to stores in a geographic region and minimizes lost sales from understocked and out-of-stock products across these stores; and serve this vehicle route to the distributor associate, such as before or as the distributor associate navigates between stores throughout this geographic region. The computer system can therefore execute Blocks of the method S100 to derive and selectively serve slot status data and restocking prompts to the distributor to enable the distributor to improve efficiency of remote slot management by the distributor and in order decrease aggregate out-of-stock and understock durations of high-value products stocked throughout the distributor's geographic region.

Furthermore, once a distributor associate arrives at a store to restock understocked or out-of-stock slots managed by the distributor, the computer system can: leverage the last stock condition of the store—derived from scans recorded by the robotic system and/or by fixed sensors deployed in the store—to calculate a route through the store that intersects locations of understocked and out-of-stock slots designated for restocking by the distributor associate during this restocking event; and then serve this route to the distributor associate, such as upon the distributor associate's arrival at the store, thereby enabling the distributor associate to quickly navigate to and restock these slots. For example, the computer system can calculate a shortest path that intersects the location of each slot designated for restocking by the distributor associate and serve this path to the distributor associate upon arrival at the store in order to enable the distributor associate to rapidly reach each of her assigned slots known to be understocked or out-of-stock, even if the delivery associate is unfamiliar with the store and without requiring the distributor associate to observe each slot managed by the distributor while present in the store. The computer system can therefore execute Blocks of the method S100 to derive and selectively serve data to a distributor associate in order to enable the distributor associate to operate more efficiently inside of a store.

However, while tracking stock states of slots designated for external management by the distributor (or by the external entity more generally) based on scan data collected by mobile and/or fixed sensors in the store and selectively serving guidance to the distributor (or external entity) to restock these slots, the computer system can concurrently: track stock states of other slots designated for internal management by the store based on scan data collected by these same sensors during the same scan cycles; detect deviations between stock states of these slots and a planogram defined by the store (or affiliated corporate governance) for these store-managed slots; and then serve real-time or grouped prompts to restock out-of-stock and understocked slots. Therefore, the computer system can leverage scan data recorded by mobile and/or fixed sensors during a scan cycle: to monitor both slots designated for internal management by the store and other slots designated for external management by affiliated distributors; and to selectively distribute restocking prompts to store or distributor associates based on management designations of these slots (or other inventory structures) in the store.

Furthermore, the method S100 is described herein as executed by the computer system: to monitor stock conditions of a store based on scan data collected by a robotic system executing a continuous scan cycle or an intermittent scan cycle in the store, such as before, during, and/or after open store hours; and to distribute restocking prompts for slots to store associates and to distributors based on management specifications for slots throughout the store. However, the computer system can execute Blocks of the method S100 to monitor stock conditions of the store based on data collected by one or more fixed sensors (e.g., fixed cameras) arranged throughout the store or any other sensor deployed to the store.

### 3. HIERARCHY AND TERMS

A “product facing” is referred to herein as a side of a product (e.g., of a particular SKU or other product identifier) designated for a slot. A “planogram” is referred to herein as a graphical representation of target locations of product facings across inventory structures within a store (e.g., across an entire store). Product identification, placement, and orientation data recorded visually in a planogram can be also be recorded in a corresponding textual product placement spreadsheet, slot index, or other store database (hereinafter a “product placement database”).

A “slot” is referred to herein as a section of a shelf designated for occupation by one product facing, including a row of one or more units of a product. A “shelf” is referenced herein as one lateral surface (e.g., one four-foot-wide horizontal surface) spanning one or more slots. A “shelving segment” is referred to herein as one column of a shelving structure, including one or more shelves. A “shelving structure” is referred to herein as a row of one or more shelving segments. An “aisle” is referred to herein as a thoroughfare between two opposing shelving structures or other inventory structures. A “store” is referred to herein as a (static or mobile) facility containing one or more shelving structures or shelving structures and one or more aisles.

A “product” is referred to herein as a type of packaged good associated with a particular product identifier (e.g., a SKU). A “unit” or “product unit” is referred to herein as an instance of a product, such as one packaged article in a set of packaged articles associated with one SKU value.

A “stock condition” of a store is referred to herein as presence or quantities of products throughout the store, such as based on scan data recorded during a last or ongoing scan cycle by the mobile robotic system operating within the store. Actual locations of product facings in the store—derived from these same scan data—can be represented in a “realogram” of the store. The computer system can thus pair the stock condition and the realogram of the store to communicate both presence (and quantities) of products in the store and locations of these products in the store, respectively, such as to enable a user to populate a shopping list with product verified as stocked in the store and/or to inform a path to retrieve products on a shopping list following arrival at the store.

The method S100 S100 is described herein as executed by a computer system (e.g., a remote server, hereinafter the “system”). However, Blocks of the method S100 S100 can be executed by one or more mobile robotic systems deployed in a retail space (or store, warehouse, etc.), by a local computer system, or by any other local or distributed computer network. Furthermore, Blocks of the method S100 S100 are described below as executed by the computer system to track stock conditions of open shelves on shelving structures within a store. However, the computer system can implement similar methods and techniques to detect and track stock conditions of cubbies, refrigeration units, wall racks, freestanding floor racks, and/or tables, etc. within a retail space.

### 4. MOBILE ROBOTIC SYSTEM

A mobile robotic system (hereinafter the “robotic system”) is configured to autonomously navigate throughout a store and to capture images of shelving structures and other product displays throughout a store. Generally, the robotic system can define a network-enabled mobile robot that can autonomously traverse a store, capture images of shelves within the store, and upload those images to a computer system for analysis.

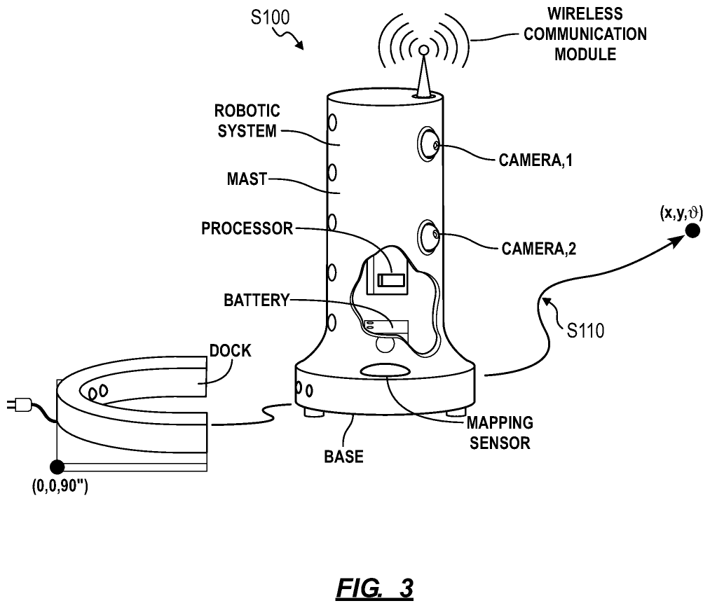

In one implementation, the robotic system defines an autonomous imaging vehicle including: a base; a drive system (e.g., a pair of two driven wheels and two swiveling casters) arranged in the base; a power supply (e.g., an electric battery); a set of mapping sensors (e.g., fore and aft scanning LIDAR systems); a processor that transforms data collected by the mapping sensors into two- or three-dimensional maps of a space around the robotic system; a mast extending vertically from the base; a set of cameras arranged on the mast; a geospatial position sensor (e.g., a GPS sensor); and a wireless communication module that downloads waypoints and a master map of a store from a computer system (e.g., a remote server) and that uploads photographic images captured by the camera and maps generated by the processor to the computer system, as shown in FIG. 3. In this implementation, the robotic system can include cameras mounted statically to the mast, such as two vertically offset cameras on a left side of the mast and two vertically offset cameras on the right side of mast, as shown in FIG. 3. The robotic system can additionally or alternatively include articulable cameras, such as: one camera on the left side of the mast and supported by a first vertical scanning actuator; and one camera on the right side of the mast and supported by a second vertical scanning actuator. The robotic system can also include a zoom lens, a wide-angle lens, or any other type of lens on each camera. However, the robotic system can define any other form and can include any other subsystems or elements supporting autonomous navigating and image capture throughout a store environment.

The robotic system also includes an RFID antenna and an RFID reader that cooperate to: broadcast an interrogation signal; and to collect and discern inbound RF signals broadcast from RFID tags excited by the interrogation signal. In one variation, the robotic system includes multiple RFID antennas. For example, the robotic system can include a first RFID antenna arranged in a first polarization orientation at a first position along the mast; and a second RFID antenna arranged in a second polarization orientation at a second position along the mast. In this example, the second polarization orientation can be angularly offset from the first polarization orientation by a known angle (e.g., 90° about a horizontal axis of the robotic system; and the second position can be vertically offset above the first position by a known distance (e.g., 50 centimeters). During a scan routine, the robotic system can: trigger both the first and second RFID antennas to broadcast interrogation signals; collect RF signals through both the first and second RFID antennas; and compile these RF signals and related metadata into a 2D or 3D map of locations of RFID tags—from which these RF signals originated—based on known linear offsets between the first and second antennas. Furthermore, a particular RFID tag parallel to the plane of propagation of an interrogation signal broadcast by the first antenna may not return an RF signal to the robotic system; however, because the second antenna is angularly offset from the first antenna, the particular RFID tag may be necessarily non-parallel to the plane of propagation of an interrogation signal broadcast by the second antenna. Therefore, the robotic system can include two (or more) non-parallel RFID antennas in order to enable collection of RF signals from a greater proportion of nearby RFID tags, including RFID tags that may be obscured from one RFID antenna in the set.

The computer system can also interface with multiple robotic systems placed in a single store and configured to cooperate to image shelves within the store. For example, two robotic systems can be placed in a large single-floor store and can cooperate to collect images of all shelves in the store within a threshold period of time (e.g., within one hour). In another example, one robotic system can be placed on each floor of a multi-floor store, and each robotic system can each collect images of shelves on its corresponding floor. The computer system can then aggregate images captured by multiple robotic systems placed in one store to generate a graph, map, table, and/or task list of properly- and improperly-stocked slots within the store.

### 4.1 Fixed Sensors

The computer system can additionally or alternatively include or interface with fixed sensors arranged throughout a store to collect optical or non-optical scan data representing products stocked throughout the store. For example, a set of fixed 2D or 3D color or hyperspectral cameras can be mounted over aisles and displays in the store and can be configured to regularly record and return scan data to the computer system, such as once per one-minute interval via the Internet or other computer network while the store is in operation.

However, the computer system can interface with any other fixed or mobile sensor deployed in a store in order to collect data representing types, quantities, and locations of product currently stocked in the store.

### 5. ROBOTIC SYSTEM DISPATCH AND STOCK CONDITION DERIVATION

Block S110 of the method S100 S100 recites, for each store in a set of stores within a geographic region, dispatching a robotic system, deployed in the store, to autonomously scan shelving structures within the store. Generally, in Block S110, the computer system can interface with mobile robotic systems deployed in various stores within a geographic region to initiate scan cycles of fixed duration (e.g., one scan of all aisles) or to initiate continuous scans (e.g., continuously during hours of operation) in these stores.

Block S112 of the method S100 S100 recites deriving a current stock condition of the store based on scan data recorded by the robotic system during the first scan cycle. Generally, in Block S112, the computer system can extract the stock condition of a store from scan data recorded by the robotic system and/or by fixed sensors deployed in the store. In one implementation, as a robotic system in a store—in this set of stores—records optical scans (e.g., 2D color images and 3D point clouds) of shelving segments and other displays in this store and returns these optical scans to the computer system, the computer system can: stitch a sequence of images recorded by the robotic system while navigating along a shelving structure into a composite image of the shelving structure; implement computer vision techniques to detect and identify shelving segments, shelves, and individual product units in the composite image; and generate a realogram of the shelving segment accordingly.

The computer system can repeat this process to generate a realogram of other shelving structures and product displays throughout the store and can compile these realograms into one composite realogram of the store, such as described in U.S. patent application Ser. No. 15/600,527 and shown in FIG. 2.

### 5.1 Scan Cycle: Waypoints

In one implementation, the computer system: defines a set of waypoints specifying target locations within the store through which the robotic system navigates and capture images of inventory structure throughout the store during a scan cycle; and intermittently (e.g., twice per day) dispatches the robotic system to navigate through this sequence of waypoints and to record images of inventory structures nearby during a scan cycle. For example, the robotic system can be installed within a store, and the computer system can dispatch the robotic system to execute a scan cycle during store hours, including navigating to each waypoint throughout the store and collecting data representative of the stock state of the store in near real-time as patrons move, remove, and occasionally return product on, from, and to inventory structures within the store (e.g., shelving structures, refrigeration units, displays, hanging racks, cubbies, etc.). During this scan cycle, the robotic system can: record black-and-white or color photographic images of each inventory structure; record thermographic images of select inventory structures in the store (e.g., refrigeration units); record multi-spectral images of other inventory structures within the store (e.g., inventory structures stocked with fresh produce); and/or broadcast radio frequency queries and record radio frequency identification (or “RFID”) data from RFID tags arranged on or integrated into products stocked throughout the store.

The computer system can therefore maintain, update, and distribute a set of waypoints to the robotic system, wherein each waypoint defines a location within a store at which the robotic system is to capture one or more images from the integrated thermographic, depth, and/or color cameras. In one implementation, the computer system defines an origin of a two-dimensional Cartesian coordinate system for the store at a charging station—for the robotic system—placed in the store, and a waypoint for the store defines a location within the coordinate system, such as a lateral (“x”) distance and a longitudinal (“y”) distance from the origin. Thus, when executing a waypoint, the robotic system can navigate to (e.g., within three inches of) a (x,y) coordinate of the store as defined in the waypoint. For example, for a store that includes shelving structures with four-foot-wide shelving segments and six-foot-wide aisles, the computer system can define one waypoint laterally and longitudinally centered—in a corresponding aisle—between each opposite shelving segment pair. A waypoint can also define a target orientation, such as in the form of a target angle (“a”) relative to the origin of the store, based on an angular position of an aisle or shelving structure in the coordinate system, as shown in FIG. 5. When executing a waypoint, the robotic system can orient to (e.g., within 1.5° of) the target orientation defined in the waypoint in order to align a camera to an adjacent shelving structure.

When navigating to a next waypoint, the robotic system can scan an environment nearby with the depth sensor (e.g., a LIDAR sensor, as described above), compile depth scans into a new map of the robotic system's environment, determine its location within the store by comparing the new map to a master map of the store defining the coordinate system of the store, and navigate to a position and orientation within the store at which the output of the depth sensor aligns—within a threshold distance and angle—with a region of the master map corresponding to the (x,y,∂) location and target orientation defined in this next waypoint. A waypoint can also include a geospatial position (e.g., a GPS location), such as in the form of a backup or redundant location. For example, when navigating to a waypoint, the robotic system can approach the geospatial position defined in the waypoint; once within a threshold distance (e.g., five feet) from the geospatial position, the robotic system can navigate to a position and orientation at which the output of the depth sensor aligns—within a threshold distance and angle—with a region of the master map corresponding to the (x,y,∂) location and target orientation defined in the waypoint.

Furthermore, a waypoint can include an address of each camera in the robotic system designated for data capture in this waypoint. For example, for the robotic system that includes a thermographic camera, a depth camera, and a color camera, the waypoint can include all or a subset of camera addresses [1, 2, 3] corresponding to a thermographic camera, a depth camera, and a color camera, respectively. Alternatively, for the robotic system that includes articulable cameras, a waypoint can define an address and arcuate position of each camera designated for image capture when the robotic system occupies this waypoint.

In this implementation, before initiating a new scan cycle, the robotic system can download—from the computer system—a set of waypoints, a preferred order for the waypoints, and a master map of the store defining the coordinate system of the store. Once the robotic system leaves its dock at the beginning of a scan cycle, the robotic system can repeatedly sample its integrated depth sensors (e.g., a LIDAR sensor) and construct a new map of its environment based on data collected by the depth sensors. By comparing the new map to the master map, the robotic system can track its location within the store throughout the scan cycle. Furthermore, to navigate to a next waypoint, the robotic system can confirm its achievement of the waypoint—within a threshold distance and angular offset—based on alignment between a region of the master map corresponding to the (x,y,∂) location and target orientation defined in the current waypoint and a current output of the depth sensors, as described above.

However, the robotic system can implement any other methods or techniques to navigate to a position and orientation within the store within a threshold distance and angular offset from a location and target orientation defined in a waypoint.

### 5.2 Scan Cycle: Dynamic Path

In another implementation, during a scan cycle, the robotic system can autonomously generate a path throughout the store and execute this path in real-time based on: obstacles (e.g., patrons, spills, inventory structures) detected nearby; priority or weights previously assigned to inventory structures or particular slots within the store; and/or product sale data from a point-of-sale system connected to the store and known locations of products in the store, such as defined in a planogram; etc. For example, the computer system can dynamically generate its path throughout the store during a scan cycle to maximize a value of inventory structures or particular products imaged by the robotic system per unit time responsive to dynamic obstacles within the store (e.g., patrons, spills), such as described in U.S. patent application Ser. No. 15/347,689.

In this implementation, the robotic system can then continuously capture images of inventory structures in the store (e.g., at a rate of 10 Hz, 24 Hz). Alternatively, the robotic system can: process depth data captured by the robotic system in real-time or scan a 2D or 3D map of the store generated during the scan cycle to track a distance from an optical sensor on the robotic system to an inventory structure nearby; and selectively trigger this optical sensor to capture images of the inventory structure at a frequency that yields a target offset (e.g., 20%, or between 10% and 40%) between consecutive images at a plane intersecting a face of the inventory structure.

However, in this implementation, the robotic system can capture images of inventory structures within the store at any other frequency during this scan cycle. The robotic system can similarly capture other scan data of these inventory structures while navigating dynamically throughout the store, such as thermographic images, multi-spectral images, and/or RFID data.

### 5.3 Scan Cycle Scheduling

In one implementation, the robotic system can continuously navigate and capture scan data of inventory structures within the store; when a state of change of a battery in the robotic system drops below a threshold state, the robotic system can return to a charging station to recharge before resuming autonomous navigation and data capture throughout the store.

Alternatively, the computer system can schedule the robotic system to execute intermittent scan cycles in the store, such as: twice per day during peak store hours (e.g., 11 AM and 6 PM on weekdays) in order to enable rapid detection of stock condition changes as patrons remove, return, and/or move products throughout the store; and/or every night during close or slow hours (e.g., 1 AM) to enable detection of stock conditions and systematic restocking of understocked slots in the store before the store opens the following morning or before a next peak period in the store.

In another implementation, the computer system can track demand for products in a geographic region based on products in pending or queued shopping lists originating in the geographic region and/or based on sale data from a point-of-sale system in the store and then queue the robotic system to scan target slots assigned to particular products exhibiting relatively high demand at the current time (e.g., over the last hour or since a last scan cycle at the store). For example, the computer system can: track demand for a particular product in the geographic region based on frequency of virtual shopping lists originating within the geographic region and containing an identifier of this particular product. Then, if demand for this particular product within the geographic region exceeds a threshold demand—such as if a quantity of units of the particular product in these pending, unfulfilled shopping lists exceeds a threshold proportion (e.g., 50%) of a quantity of units of the particular product predicted to occupy all slots designating the particular product in the store based on the current stock condition of the store—the computer system can: dispatch the robotic system to autonomously capture a set of images of inventory structures containing slots assigned to the particular product within the store; scan this set of images for presence of the particular product in each slot in this set of slots assigned to the particular product; and then update a current stock condition of the store for this period of time to reflect presence of the first product in this set of slots thus derived from these images.

Therefore, the computer system can dynamically schedule scan cycles for the robotic system in order to access availability data for targeted products based on elevated demand for these targeted products in the geographic region, as indicated by pending or queued shopping lists originating in this geographic region. The computer system can then leverage these targeted availability data to preemptively reroute a delivery associate to another store that contains more products on a shopping list assigned to this delivery associate, reroute a user to another store that contains more products on her shopping list, or prompt a user to remove or elect an alternate or backup product for her shopping list, as described below, responsive to reduction in availability of a product indicated on a shopping list assigned to this store.

However, the computer system can dispatch the robotic system to execute scan cycles according to any other fixed or dynamic schedule.

### 5.4 Scan Data Processing

Therefore, while autonomously navigating along a particular aisle in this set of aisles in the store, the robotic system can record a set of photographic images of a set of shelving structures facing the particular aisle. The robotic system can then upload these photographic images of inventory structures in the particular aisle to the computer system for remote processing, such as in real-time or upon conclusion of the scan cycle.

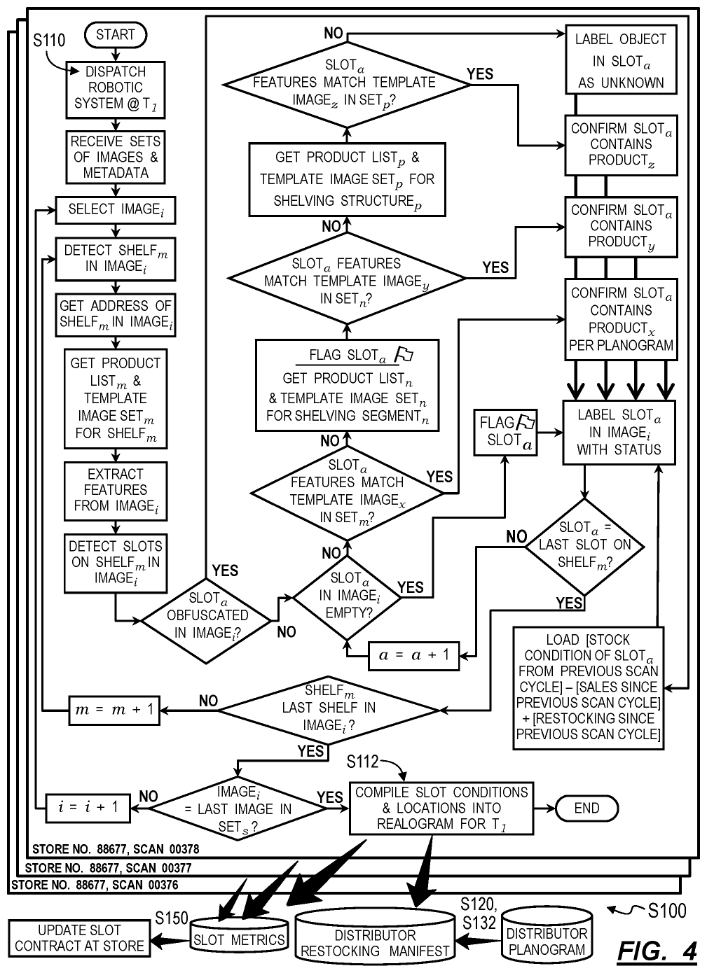

As shown in FIG. 4, the computer system can then: detect a first shelf in a first shelving structure in a first region of a first photographic image, in the set of photographic images, recorded at approximately the first time; identify an address of the first shelf; retrieve a first list of products assigned to the first shelf by a planogram of the store based on the address of the first shelf; retrieve a first set of template images from a database of template images, wherein each template image in the first set of template images depicts features of a product in the first list of products; extract a first set of features from the first region of the first photographic image; and determine that a unit of the first product is stocked on the first shelf in response to alignment between features in the first set of features and features in the first template image.

Alternatively, the computer system can determine that a unit of the first product is improperly stocked on the first shelf in response to deviation between features in the first set of features and features in the first template image. Then, in response to determining that the unit of the first product is improperly stocked on the first shelf, the computer system can generate a restocking prompt for the first product on the first shelf and serve this restocking prompt to an associate of the store in real-time. Alternatively, the computer system can: append a global restocking list for the store with a restocking prompt to restock the first product on the first shelf; and later serve this global restocking list to an associate of the store, such as upon conclusion of the scan cycle, as described in U.S. patent application Ser. No. 15/600,527.

The computer system can then log the stock condition of the first product on the first shelf (or in a particular slot on the first shelf), such as in a stock condition record for the store. The computer system can repeat this processes for each other slot, shelf, shelving segment, shelving structure, and/or other inventory structure depicted in scan data captured by the robotic system during this scan cycle, including: selectively generating and distributing restocking prompts for empty (and understocked) slots and shelves; and logging stock conditions of these products in their assigned slots or shelves.

The computer system can implement similar methods and techniques to track and log stock conditions of products in the store based on thermographic images, multi-spectral images, and RFID data collected by the robotic system during this scan cycle.

The computer system can then store this stock condition of the store for this scan cycle, such as in the form of a table or list: containing product identifiers paired with slot addresses (and unit quantity) for each product detected in scan data recorded during this scan cycle; and timestamped with a start time, end time, or time window of the scan cycle. However, the computer system can record the stock condition of the store—thus derived from scan data recorded by the robotic system during this scan cycle and timestamped according to this scan cycle—in any other format.

Furthermore, the computer system can repeat this process to generate subsequent, timestamped stock condition records for the store based on scan data recorded by the robotic system during the first scan cycle during later scan cycles.

### 5.5 Product Availability

Therefore, a last stock condition record thus generated by the computer system—based on scan data recorded by the robotic system during a last scan cycle at the store—may approximate availability of products throughout the store at the time of this last scan cycle. Following this scan cycle and before a next scan cycle at the store, the computer system can also: ingest product sales from a point-of-sale system at the store, such as in the form of product identifiers, product quantities, and times of sale events at the store; ingest product restocking data from a restocking system at the store, such as in the form of product identifiers, product quantities, and times of restocking events at the store; and update product quantities in the last stock condition record to reflect these sale and restocking events. More specifically, the computer system can update the last stock condition record of the store based on product sales and restocking data—accessed from these other services deployed in the store—such that this stock condition record approximates a true state of the store at any time after this last scan cycle.

The computer system can then reset this stock condition record based on product data extracted from scan data recorded by the robotic system during a next scan cycle. However, a subset of slots in the store may be obscured in scan data recorded during this next scan cycle—such as by patrons, temporary (e.g., cardboard) product displays, or boxes—such that these scan data omit information relevant to deriving stock conditions of this subset of slots. Therefore, the computer system can: continue to update stock condition of this subset of slots in the store based on product sales and restocking data accessed from point-of-sale and restocking services deployed in the store; and update the stock condition of other slots in the store based on scan data collected by the robotic system during this next scan cycle.

The computer system can therefore: store a stock condition for a particular slot thus derived from scan data—depicting the particular slot—recorded during a last scan cycle as a “ground truth” stock condition of this particular slot; decrement the stock condition for this particular slot based on sales of a product assigned to the particular slot thus derived from sale data following this last scan cycle; and increment the stock condition for this particular slot based on restocking data for this product following this last scan cycle. The computer system can then reset the stock condition for this particular slot based on a next set of scan data—captured during a subsequent scan cycle—that depicts this particular slot. The computer system can implement this process for each slot in the store and compile these slot-specific stock conditions for (many or all) slots in the store into one aggregate stock condition record for the store.

Alternatively, the computer system can store a stock condition for a particular slot thus derived from most-recent scan data depicting the particular slot as a “ground truth” stock condition of this particular slot and timestamp this stock condition for the particular slot with a time of the scan cycle in which these scan data were recorded. The computer system can repeat this process for each other slot in the store based on most-recent scan data depicting these slots in order to generate a corpus of stock conditions of individual slots labeled with timestamps for various past scan cycles. The computer system can then compile stock conditions of these individual slots into one aggregate stock condition record for the store.

For example, for a first product detected in scan data recorded by the particular robotic system during both a first scan cycle and a second, subsequent scan cycle, the computer system can: derive current availability of the first product based on scan data recorded during the second scan cycle; and store this availability of the first product—in a current stock condition record of the store—with a timestamp for the second scan cycle. However, for a second product detected in scan data recorded by the particular robotic system during the first scan cycle but obscured in scan data recorded by the particular robotic system during the second scan cycle, the computer system can: retrieve past availability of the second product derived from scan data recorded during the first scan cycle; and store this past availability of the second product—in the current stock condition record of the store—with a timestamp for the first scan cycle. Later, the computer system can serve these timestamps or time since last confirmed availability of products in the store to a customer portal. A user at the customer portal may then interpret these timestamps or time spans as measures of confidence or accuracy of indicated availability of these products in the store.

However, the computer system can implement any other method or technique to track and store availability of products in the store over time.

### 5.5 Product Location Tracking

Similarly, because a subset of slots in the store may be obscured from the robotic system during a scan cycle, the computer system can aggregate product locations derived from scan data collected over multiple scan cycles into one product location map (or “realogram”) of the store that represents true locations of (substantially, nearly) all products in the store. In particular, the computer system can aggregate stock conditions of the store derived from scan data recorded during multiple consecutive scan cycles—such as four scan cycles over a period of 48 hours—to generate a product location map that identifies locations of substantially all products in the store. For example, the computer system can: calculate a union of product locations derived from scan data recorded during the last four scan cycle; and store this union in the form of a product location map or realogram that represents true locations of products throughout the store.

The computer system can then leverage this realogram to aggregate a list of locations or addresses of products contained in a shopping list and/or to define a route—through the store—to each product contained in a shopping list, as described below.

### 5.6 Other Stores

The computer system can implement similar methods and techniques: to queue robotic systems—deployed to other stores in the same geographic region—to execute scan cycles in their corresponding stores; to derive stock conditions of slots throughout these stores based on scan data collected by these robotic systems; and to maintain current stock condition records for these stores over time based on new inbound scan data, sales data, and/or restocking data.

### 6. STORE V. DISTRIBUTOR SLOT ALLOCATION

The computer system can also manage a representation of slots in the store that are the responsibility of the distributor to manage. In one implementation, the computer system interfaces with a store manager—such as via a store manager portal executing on a local mobile or desktop computing device—to upload a planogram of the store, such as described in U.S. patent application Ser. No. 15/600,527. The computer system can then prompt the store manager to manually label each slot, shelving segment, shelving structure, product display, and/or refrigeration unit, etc.—represented in the planogram—designated for management by an external distributor (or brand, or consumer product company). For example, the computer system can interface with the store manager portal to prompt the manager to scroll through a virtual representation of each inventory structure in the store, to manually select individual slots or groups of slots in these virtual inventory structure representations, to manually label these slots as the responsibility of a particular external distributor, and to enter contact information for the particular distributor.

In this implementation, the computer system can then: activate a distributor manager account or portal according to contact information provided for the distributor by the store manager; serve a prompt to a distributor manager via the distributor manager portal to confirm each slot thus designated for management by the distributor; and label slots thus confirmed by the distributor manager in a database, table, spreadsheet, or planogram representation of the store. For example, the computer system can: tag these confirmed slots with distributor contact information in the planogram of the store or write identifiers of these slots and contact information of the distributor to a separate slot management spreadsheet for the store; and then reference the planogram or slot management spreadsheet to selectively push restocking information to the distributor when the computer system determines from scan data—recorded by fixed and/or mobile sensors deployed in the store—that one of these slots is understocked or out-of-stock.

The computer system can separately label slots not designated for management by an external distributor (or brand, or consumer product company) or otherwise confirmed as managed by the store and then distribute restocking prompts for these other slots directly to the manager or other associates of the store when the computer system detects out-of-stock or understock conditions in these slots.

In another implementation, the computer system accesses a prepopulated spreadsheet, table, external planogram, or contract—such as via the store manager portal or distributor manager portal—that contains: a list of slot, shelving segment, shelving structure, product display, and/or refrigeration unit addresses allocated for an external entity's or distributor's products; designation of these inventory structures for external management (e.g., by the distributor) and/or internal management (e.g., interim restocking and straightening by store associates between distributor deliveries); identifiers, locations, and quantities of products assigned to these inventory structures by the external entity or distributor; and contact information for the external entity or distributor tasked with managing these inventory structures. In this implementation, the computer system can then: extract a set of slot addresses—that are the responsibility of an external distributor to manage—from this spreadsheet or other container; tag these slot addresses in the internal store planogram with distributor contact information; and/or tag these slot addresses in a current realogram of the store with distributor contact information.

In a similar implementation, the computer system stores: an internal store planogram controlled by a store manager or affiliated corporate governance and specifying product identifiers and quantities for slots in the store designated for internal management by the store; and a set of external planograms, each external planogram controlled by an external entity or distributor and specifying product identifiers and quantities for slots in the store designated for external management by the distributor. In this implementation, after generating a new realogram of the store based on scan data captured during a last scan cycle by the robotic system and/or based on data collected by fixed sensors in the store, the computer system can: transfer slot management tags from the internal and external planograms onto the current realogram to label out-of-stock and understocked slots with identifiers of responsible parties; aggregate a first subset of out-of-stock and understocked slots designated for store management; aggregate a second subset of out-of-stock and understocked slots designated for management by a first distributor; and aggregate a third subset of out-of-stock and understocked slots designated for management by a second distributor; etc. The computer system can then implement methods and techniques described below to generate and distribute restocking prompts to associates of the store, the first distributor, and/or the second distributor, etc.

However, the computer system can implement any other method or technique to identify a subset of slots, shelving segments, shelving structures, product displays, refrigeration units, and/or other inventory structures in the store designated for management by a distributor or other entity external to the store.

### 6.1 Endcaps

In one variation, the computer system implements similar methods and techniques to identify endcaps contracted for display of the distributor's or external entity's product. For example, the computer system can prompt a manager of the store—via the store manager portal—to label an endcap represented in a planogram (or realogram) of the store with: a brand, a specific product category supplied by the brand, and/or a specific product supplied by the brand; and rules for display of product on the endcap, such as whether products by other brands are also permitted on the endcap and a duration of a contract for this endcap. The computer system can also: collect contact information for the brand or for a local distributor affiliated with the brand, product category, or product assigned to the endcap; and serve a prompt to a manager of the brand or distributor to confirm these values for the endcap in the store. Once confirmed by the brand or distributor, the computer system can tag a representation of the endcap in the planogram (or realogram) with these data and/or write data to a separate slot management spreadsheet for the store. However, the computer system can implement any other method or technique to collect and verify stock targets and related information for an endcap in the store.

### 6.2 Planogram Generation

As described above, the computer system can access pre-generated planograms or other documentation specifying slot locations, product allocation, and management of inventory structures throughout the store.

Alternatively, the computer system can automatically generate a planogram based on scan data recorded by the robotic system deployed in the store, as described in U.S. patent application Ser. Nos. 15/600,527 and 15/600,591—wherein this planogram specifies a target (or “ideal,” or “fully-stocked”) stock condition of the store. The computer system can then annotate the planogram with management responsibilities and target stock conditions of slots and other inventory structures throughout the store based on inputs from a store manager, a retail buyer associated with the store, merchandise representative or category manager associated with the store's corporate entity, a distributor, a brand, and/or a consumer product company, etc. via correspond portals. The computer system can then implement Blocks of the method S100 to selectively serve restocking prompts for these slots to corresponding entities indicated in this annotated planogram.

(The computer system can implement similar methods and techniques to manage a representation of slots in the store that are the responsibility of the a store manager, a retail buyer, a merchandise representative, a category manager, etc.)

### 7. SLOT MONITORING AND DEVIATION DETECTION

Block S120 of the method S100 recites, based on a difference between the current stock condition and a planogram of the store, identifying a subset of understocked slots in the store designated for management by a distributor external to the store. Generally, in Block S120, the computer system can merge a planogram of the store—annotated with management responsibilities for slots throughout the store—and a current stock condition of the store (e.g., in the form of a realogram) to isolate a set of slots: that are currently understocked, out-of-stock, disheveled, or contain out-of-date products; and that are the responsibility of an external distributor (or brand, or consumer product company) to manage.

In one variation, Block S120 similarly recites: based on the current stock condition of the store, detecting a first deviation between a current state of a first slot in a first inventory structure in the store and an internal target stock condition of the first slot defined by an affiliate of the first store; and, based on the current stock condition of the store, detecting a second deviation between a current state of a second slot in a second inventory structure in the store and an external target stock condition of the second slot defined by an entity external to the store and affiliated with a second product assigned to the second slot. Generally, in this variation, the computer system can merge the current realogram or other representation of the current stock condition of the store with internal and/or external planograms for the inventory structure throughout the store to detect deviations from target stock conditions specified in these planograms and then selectively flag these inventory structures for restocking or correction based on management responsibilities assigned to these inventory structures.

### 7.1 Individual Slots

In one implementation, the computer system characterizes stock state of individual slots in the store. For example, the computer system can identify a particular slot as out-of-stock and flag this slot for restocking if no product is detected in last scan data depicting the slot. Similarly, the computer system can identify a particular slot as understocked and flag this slot for restocking if fewer than a target quantity (e.g., “two units”) or less than a threshold proportion (e.g., 2 of 6) of units of this product assigned to the slot by the planogram are detected at the location of the slot in scan data captured by the robotic system during the last scan cycle at the store. In another example, the computer system can identify a particular slot as improperly stocked and flag this slot for correction if a product other than the product assigned to the slot in the planogram is detected in last scan data depicting the slot.

In yet another example, the computer system can: implement a database of product characteristics of products carried in the store—such as in the form of template images or feature models—both currently and in the past to identify products depicted in a scan cycle captured by the robotic system during a scan cycle; matches features in scan data corresponding to a particular slot to a template image or feature model corresponding to a particular product tagged as out-of-date (e.g., a product containing seasonal packaging from a past season, a discontinued product); and thus labels this particular slot as containing a unit of the particular product that is out-of-date in Block S120. In this example, the robotic system can then serve a prompt—to the distributor assigned to manage this particular slot—to retrieve this unit of the out-of-date product and to restock the particular slot with current (or “in-date”) units of the particular product. Alternatively, in this example, the remote controller can: serve a prompt to a store associate to remove this unit of the out-of-date product from the particular slot; and/or serve a prompt to the distributor to deliver current (or “in-date”) units of the particular product to the store during a next scheduled delivery.

### 7.2 Slot Clusters

The computer system can additionally or alternatively monitor a cluster of slots on a shelf, shelving segment, or shelving structure and characterize a stock state of this cluster of slots. For example, the computer system can flag a cluster of slots—designated for the same product—if certain conditions are detected across this cluster in scan data recorded by the robotic system during a scan cycle, such as: if a threshold proportion of slots in the cluster are out-of-stock (e.g., 20%); if less than a target proportion of product units allocated to the cluster by the planogram are present across this cluster of slots (e.g., less than 40% of the allocated quantity of product units); or if an incorrect product is detected in any slot in the cluster.

However, the computer system can flag an individual slot or a cluster of slots in the store responsive to any other deviation from the target state of the slots or cluster of slots indicated in the planogram.

### 8. RESTOCKING PROMPTS

Block S134 of the method S100 recites, in response to detecting the first deviation, serving a first prompt to restock the first slot to an associate of the first store; and Block S132 of the method S100 recites, in response to detecting the second deviation, serving a second prompt to restock the second slot to a distributor external to the first store in Block S132. Generally, in Blocks S132 and S134, the computer system can selectively distribute prompts or metrics related to stock states of inventory structures in the store designated for external and internal management, respectively, to corresponding parties.

In one implementation, the computer system: aggregates a first group of understocked, out-of-stock, or disheveled slots and slot clusters (or “flagged slots” and “flagged slot clusters”) designated for management by the store according to the internal store planogram; and serves restocking prompts to store associates for this first group of flagged slots and flagged slot clusters. For example, the computer system can: serve prompts to restock a first subset of these flagged slots—allocated for high-value products as described below—to store associates in (near) real-time; and aggregate prompts to restock a second subset of these flagged slots—allocated for lower-value products—into a global restocking list and serve this to global restocking list store associates during a later scheduled restocking period in the store. In this implementation, the computer system can separately: aggregate a second group of flagged slots and flagged slot clusters assigned to a distributor by the internal store planogram or by an external planogram; and selectively serve restocking prompts for this second group of slots and slot clusters to the distributor, such as: if the aggregate value of products assigned to these slots exceeds a threshold value; if the aggregate packaging volume of products assigned to these slots exceeds a threshold volume; if a delivery from the distributor to the store is currently scheduled; or if an option for delivery from the distributor to the store is currently active.

8.1. Internal v. External Restocking Quantities

In one implementation, the computer system selectively distributes prompts to store associates to restock slots designated for internal management and distributes prompts to the distributor to other restock slots designated for external management based on different trigger or threshold conditions that reflect different levels of accessibility of these slots to store and distributor associates.

In one example, the computer system detects presence of a quantity of units of a first product on a first inventory structure—designated for internal management—in the store and presence of a quantity of units of a second product on a second inventory structure—designated for external management—in the store based on a current stock condition of the store. The computer system then: accesses an internal planogram—defined by a manager, corporate governance, or other affiliate of the store—defining internal target stock conditions of a set of slots designated for internal management by the store; extracts a target identifier and quantity of the first product assigned to a first slot on the first inventory structure from the internal planogram; identifies a deviation from an internal target stock condition of the first inventory structure if the quantity of units of the first product is less than a quantity assigned to this inventory structure by the internal planogram; and flags the first inventory structure for restocking. Accordingly, the computer system can: serve a targeted prompt to immediately restock the inventory structure—with a difference between the actual stocked and target quantities of units of the first product—to a store associate's mobile device in (near) real-time if the value of the first product or slot is high (e.g., exceeds a threshold value, margin, or sale rate); or write a flag to restock the first inventory structure with additional units of the particular product to a global restocking list for completion during a later scheduled restocking period in the store.

However, given a greater burden of restocking inventory structures in the store for the (remote) the distributor, the computer system can withhold a prompt to restock the second inventory structure if at least some units of the second product are present on the second inventory structure and even if a deviation from the target external stock condition (e.g., fewer than a target quantity of units) is detected at the second inventory structure. Additionally or alternatively, in response to detecting this deviation at the second inventory structure, the computer system can: access availability of the distributor to return to the store (e.g., a number of hours or days before a next delivery to the store); and serve an intermediate prompt to a store associate to restock the second inventory structure with units of the second product on behalf of the distributor if the distributor's availability is limited (e.g., method or technique than one day before a next possible distributor delivery to the store).

However, if the computer system detects absence of units of the second product (i.e., an out-of-stock condition) on the second inventory structure—designated for external management—in the store based on a stock condition of the store derived from data collected during a later scan cycle, the computer system can immediately queue the distributor to return to the store to restock the second inventory structure with units of the second product. For example, the computer system can: generate a prompt to restock the second inventory structure at the store with a target quantity of units of the second product—specified in the external planogram set for the store by the distributor or other external entity—and to deliver an excess quantity of units of the second product for inventory (e.g., warehousing, back-of-store storage) to the store; and then serve this prompt to the distributor, such as by inserting this prompt into the distributor's delivery queue or delivery schedule.

Alternatively, in this implementation, the computer system can predict a future out-of-stock state of the second product on the second inventory structure by extrapolating past and current stock conditions of the second inventory structure derived from scan data collected by the robotic system during multiple, consecutive scan cycles at the store. Similarly, the computer system can predict a future out-of-stock condition of the second inventory structure by extrapolating a current stock condition of the second inventory structure—derived from data collected by the robotic system during a last scan cycle—and live point-of-sale data for the store. The computer system can then queue the distributor to deliver units of the second product to the store prior to a predicted future out-of-stock state of the second product on the second inventory structure or in the store as a whole. For example, the computer system can schedule this next distributor delivery event at the store at a future time: that precedes any predicted out-of-stock conditions for all slots managed by the distributor (or for a subset of high-value slots managed by the distributor) at this store and other stores nearby; and that maximizes a volume of products delivered to stores per delivery period.

### 8.2 Product Distribution

In another implementation, the computer system monitors spatial differences between actual and target distribution of products on an inventory structure designated for management by the distributor and selectively returns prompts to the distributor to organize this inventory structure. For example, the computer system can: access an external planogram defined by the external entity, contracted between the external entity and the store, and defining external target stock conditions for the products on an inventory structure in the store; detect locations of units of products of one or more types on this inventory structure based on scan data collected by the robotic system during a last scan cycle; identify a deviation from this contract if locations of units of products on this inventory structure differ from a spatial distribution of units of products assigned to this inventory structure in the external planogram; and then serve a prompt to the distributor to reorganize the inventory structure if this deviation exceeds a threshold magnitude. For example, the computer system can notify the distributor of this spatial deviation if product centers of more than 40% of units detected on the inventory structure are offset from the centers of their assigned slots on the inventory structure by more than 50% of the packaging widths of these products.

In this implementation, by default, the computer system can also prompt a store associate to straighten products on this inventory structure if this spatial deviation exceeds a minimum threshold (e.g., product centers of more than 20% of units detected on the inventory structure are offset from the centers of their assigned slots on the inventory structure by more than 30% of the packaging widths of these products). However, if the computer system determines from the same or subsequent scan data that this spatial deviation now exceeds a maximum threshold (e.g., product centers of more than 60% of units detected on the inventory structure are offset from the centers of their assigned slots on the inventory structure by more than 60% of the packaging widths of these products), the computer system can further prompt the distributor to return to the store to straighten this inventory structure. Additionally or alternatively, the computer system can prompt the distributor to return to the store to straighten this inventory structure responsive to detecting a spatial deviation for the inventory structure that exceeds a threshold deviation for more than a threshold duration of time (e.g., product centers of more than 30% of units detected on the inventory structure are offset from the centers of their assigned slots on the inventory structure by more than 30% of the packaging widths of these products for more than 24 hours).

Alternatively, in response to detecting a spatial deviation at the inventory structure, the computer system can: implement methods and techniques described below to retrieve scan data (e.g., photographic images) recorded during the last scan cycle and depicting the inventory structure; crop or redact these scan data to depict only slots and products associated with and/or managed by the distributor and external entity; and serve this cropped scan data to the distributor (or external entity) with a prompt to either verify the current spatial distribution of products on the inventory structure, queue the store to organize the inventory structure according to the stored external planogram, or dispatch a discrepancy associate to correct the inventory structure. Then, if the distributor (or external entity) verifies the current spatial distribution of products on the inventory structure, the computer system can update the external planogram to reflect the distribution of products depicted in these scan data. (Alternatively, in this implementation, the computer system can generate a realogram of the slots on the inventory structure contracted with the distributor or external entity and then serve this realogram to the distributor for verification of the current spatial distribution of products on the inventory structure.) Therefore, the computer system can detect spatial deviations of products on the inventory structure from a target distribution of these products defined in the external (or internal store) planogram and then enable the distributor to either update the external (or internal store) planogram to reflect this current distribution or trigger reorganization of the inventory structure to better align with the current external (or internal store) planogram.

However, the computer system can implement any other method or technique to detect and respond to a difference between actual and target distribution of products in slots assigned to or contracted by the distributor or external entity.

### 8.3 Interim In-Store Restocking Prompts

As described above, the computer system can also serve interim prompts to store associates to restock slots designated for management by the distributor, such as selectively responsive to detecting an out-of-stock condition at a distributor-managed slot rather than merely an understock condition of this distributor-managed slot or responsive to detecting a high sale rate of product assigned to a particular distributor-managed slot in the store.

In one implementation, in response to detecting an out-of-stock condition of a distributor-managed slot, the computer system can prompt a store associate to restock this slot if the distributor confirmed back-of-store delivery of additional units of the corresponding product during a last delivery event at the store, if additional units of the product are currently noted in a back-of-store inventory system for the store, or if additional units of the product are otherwise predicted or confirmed to be in inventory at the store. The computer system can also update an order or schedule for the distributor to reflect need for delivery of additional units of the product to the store. Furthermore, because the computer system has prompted local store associates to manage this slot, the computer system can also delay transmission of a prompt to the distributor to service the store, thereby reducing immediate burden on the distributor to address this out-of-stock condition.

The computer system can implement similar methods and techniques: to serve interim prompts to store associates to address understock and disordered slots designated for management by the distributor; and to suppress, delay, or deprioritize distribution of prompts related to such as understock and disordered conditions to the distributor in order to reduce immediate burden on the distributor to address such conditions at the store.

### 8.4 Other Stores

The computer system can repeat the foregoing processes in parallel to serve restocking prompts—for slots and inventory structures throughout many stores in a geographic region serviced by the distributor—to the distributor based on scan data recorded by fixed and/or mobile sensors deployed in these stores.

### 9. RESTOCK RANKING

One variation of the method S100 includes: Block S130, which recites ranking stores, in the set of stores, based on values of subsets of understocked slots in the set of stores; and Block S132, which recites dispatching a distributor associate to a particular store, in the set of stores, to restock a particular subset of understocked slots in the particular store based on a rank of the particular store. Generally, in Blocks S130 and S132, the computer system can rank stores in the geographic region as a function of type and quantity of out-of-stock and understocked slots—managed by the distributor—currently detected in these stores and then selectively dispatch the distributor associate to these stores to restock these slots.

### 9.1 Slot Value

In one implementation, when the computer system detects an out-of-stock or understocked condition in a slot in a store and then confirms responsibility of the distributor to manage this slot, the computer system: retrieves a margin (or a “profitability,” a currency value) of a product assigned to the slot; retrieves an historical sale rate for the product from this slot in the store, such as at the current time of day, day of the week, and/or day of the year; and then calculates a slot value for the slot proportional to the margin, the historical sale rate of product from the slot, and the difference between the current stock state of the slot and the target stock state of the slot, as specified in the planogram. In this implementation, the computer system can repeat this process for each other out-of-stock or understocked slot—in the store—managed by the distributor.

For example, for one slot in a subset of understocked slots—designated for management by the distributor—in a store, the computer system can: detect a quantity of units of a product, assigned to the slot, absent from the slot based on a planogram of the store and a current stock condition of the store; access a per-unit margin of the product for the distributor (or a composite representation of margin of the product for the store and distributor combined); and calculate a value of the slot based on a combination (e.g., a mathematical product) of the quantity of units of the product and the margin of the product assigned to the slot. As described above, the computer system can also adjust the value of this slot proportional to a live, recent, or predicted sale rate of the product, such as based on live, recent, or historical point-of-sale data for the store. The computer system can: repeat these process for each other out-of-stock and understocked slot in this subset of slots, in the store, designated for management by the distributor; and then calculate a restock score for the store based on a combination (e.g., a sum) of values of slots in this subset of out-of-stock and understocked slots. The computer system can also: repeat this process for each other store in the geographic region serviced by the distributor to calculate restock scores for these stores; rank stores—in this set of stores in the geographic region—based on their restock scores; and then selectively queue or prompt the distributor to selective deliver products to these stores based on their rankings.

In one implementation, the computer system: retrieves a geospatial location of the store and a distributor associate affiliated with the distributor; and calculates a restock score for the store proportional to a total quantity of these out-of-stock and understocked slots—managed by the distributor—weighted by their slot values and inversely proportional to a distance (or estimated time) between the distributor associate and the store. The computer system can repeat this process for each other store in the geographic region to calculate restock scores for each of these stores and rank these stores by their restock scores. The computer system can then serve this ranked list of stores to the distributor associate, who may then navigate a delivery truck stocked with the distributor's product to these stores and restock slots of these stores in order store rank.

### 9.2 Real-Time Value Verification

In one variation, the computer system: implements this process at the beginning of the distributor associate's shift; aggregates a list of products and product quantities to restock across these stores; and serves this list to the distributor associate prior to departure from the distributor. The distributor can then load the distributor associate's delivery vehicle with product on this list prior to departure in order to ensure that the delivery vehicle and the distributor associate are prepared to restock most or all out-of-stock and understocked slots in stores on this ranked list of stores.

The computer system can additionally or alternatively recalculate rankings for these stores, such as in real-time as the computer system recalculates current stock conditions of these stores based on scan data recorded by fixed and/or mobile sensors deployed in these stores. For example, the computer system can implement a cost function to calculate a route—for navigating to stores in the geographic region to restock out-of-stock or low-stock slots—that minimizes time that these slots are out-of-stock or understocked, such as weighted by product margin, and minimizes distance traveled by the distributor associate. The computer system can serve this route to a mobile computing device (e.g., a smartphone, a tablet) affiliated with the distributor associate, such as in the form of an annotated map including lists of products and product quantities to deliver to each store. The distributor associate can execute this proposed route to restock slots in these stores; and the computer system can then update this route over time as the distributor associate restocks slots in these stores and as slots managed by the distributor are emptied throughout these stores.

### 10. RESTOCKING EVENT SCHEDULING

In one variation, the computer system directly schedules restocking of select stores and/or select inventory structures in these stores by the distributor based on: rankings of these stores; individual slot values; packaging volume of units of products to return these slots to their target stock conditions; and/or locations and physical proximity of these stores to the distributor. For example, the computer system can generate a delivery route between a subset of stores containing slots for restocking by the distributor, tag each store location along this route with a set of product identifiers and quantities for restocking at the corresponding store, aggregate a manifest of all product identifiers and quantities for restocking across these stores during this delivery, and schedule this delivery on a distributor calendar for subsequent completion by a distributor associate.

In one implementation, the computer system schedules the distributor to restock stores in the geographic region based directly on store rank, such as including dispatching a distributor associate to a first store to restock a first subset of understocked slots in the first store during a next delivery period but delaying delivery of product to a second store of if a first rank of the first store exceeds a second rank of a second store.

In another implementation, the computer system selectively schedules the delivery of product to stores in the geographic region by the distributor until a minimum packaging volume—of units of products needed to return slots in these stores to their target stock condition—exceeds a minimum proportion (e.g., 80%) of the volume of a delivery truck employed by the distributor, thereby maintaining a high degree of efficiency for delivery periods performed by distributor associates within the geographic region.

For example, the computer system can implement methods and techniques described above to: dispatch robotic systems to execute scan cycles in this set of stores; access scan data collected by these robotic systems during these scan cycles; derive stock conditions of these stores from these scan data; isolate out-of-stock and understocked slots throughout these stores; and aggregate a manifest of products assigned to out-of-stock and understocked slots also designated for management by the distributor. The computer system can then: retrieve packaging volumes of products on this manifest, such as from a database of packaging volumes by product identifier (e.g., SKU number); and calculate an aggregate volume of products absent from slots, designated for management by the distributor, across the set of stores. Then, if this aggregate volume is less than a minimum proportion (e.g., 80%) of the volume of a delivery truck employed by the distributor, the computer system can delay serving a prompt to the distributor or otherwise queuing the distributor to initiate a delivery period to these stores. However, if this aggregate volume of products absent from slots across the set of stores is more than the minimum proportion and less than a maximum proportion (e.g., 98%) of the volume of the delivery truck, the computer system can: generate a delivery route from the distributor to these stores; tag each store location along this route with a set of product identifiers and quantities for restocking at the corresponding store; aggregate a manifest of all product identifiers and quantities for restocking across these stores during this delivery; and schedule this delivery on a distributor calendar for subsequent completion by a distributor associate or otherwise.

However, if this aggregate volume of products absent from slots across the set of stores is more than the maximum proportion of the volume of the delivery truck, the computer system can implement a cost function to isolate a subset of slots across these stores to restock during a next delivery period by the distributor. For example, the computer system can implement a cost function that isolates a subset of these slots for restocking to yield: a target proportion of the volume of the delivery truck (e.g., 98%) filled with products for restocking at these slots; a minimum distance traversed or minimum travel time by the delivery truck to reach stores containing these slots; a maximum aggregate value of slots returned to their target stock conditions during this delivery period; a minimum duration of time that slots managed by the distributor spend in an out-of-stock state; and/or a minimum duration of time that slots managed by the distributor spend in an understocked state. The computer system can then: generate a delivery route from the distributor to each store containing a slot in this subset of slots; tag each store location along this route with a set of product identifiers and quantities for restocking at the corresponding store; aggregate a manifest of all product identifiers and quantities for restocking across this subset of slots during this delivery; and schedule this delivery on a distributor calendar for subsequent completion by a distributor associate.

For example, the computer system can repeat the foregoing process prior to a scheduled delivery period by the distributor, such as between 3:30 AM and 3:55 AM on weekday mornings in order to generate a manifest for a delivery truck scheduled for loading at the distributor by at 4 AM. Alternatively, the computer system can implement the foregoing process to continuously track stock conditions of slots in stores across the geographic region and to schedule ad hoc delivery periods to these stores based on the foregoing parameters.

However, the computer system can implement any other method or techniques to selectively dispatch a distributor associate to a store to restock a slot contained in the store based on a measured stock condition of the store.

### 11. PREDICTIVE DISPATCH TRIGGERS

The computer system can implement similar methods and techniques to selectively dispatch a distributor associate to a store to restock a slot contained in the store based on a predicted future stock condition of the store.

In this variation, the computer system extracts trends in product sales from slots in the store based on historical stock conditions of the store. For example, the computer system can: aggregate a time series of stock conditions of the store derived from scan data recorded by fixed and/or mobile sensors deployed in the store; access a record of restocking events in the store (or estimate these restocking events based on increases in product quantities from one derived stock condition to the next derived stock condition); and calculate a trend of product removal from slots or slot clusters throughout the store, such as a parametric function of time of day and time of year accounting for holidays, regional events (e.g., national football league games), and/or local events (e.g., local high school and college graduation weekends), etc.

The computer system can then leverage these trends and the current stock condition of the store to predict times to future out-of-stock conditions and/or understocked conditions in slot or slot clusters throughout the store. For example, because a distributor associate assigned to restock certain slots in the store may be minutes or hours away from the store at any given time, the computer system can: leverage these trends in product sales in the store to predict future times at which these slots assigned to the distributor associate will be out-of-stock or understocked; and then preemptively dispatch the distributor associate to the store to restock these slots before such out-of-stock or understocked conditions occur.

In one implementation, the computer system: accesses scan data recorded by a robotic system during a first scan cycle in a store; derives a first stock condition of the store at a first time based on these scan data recorded by the robotic system during this first scan cycle; accesses scan data recorded by the robotic system during a subsequent scan cycle in the store; and derives a second stock condition of the store at a second time based on these scan data recorded by the robotic system during this second scan cycle. The computer system then extrapolates a future stock condition of the store—including future stock states of slots designated for management by the distributor—at a future time following the second scan cycle, such as based on a difference between the first and second stock conditions of the store at approximately the first and second times. For example, the computer system can extrapolate this future stock condition of the store—including future stock states of slots designated for management by the distributor—at a third time coincident a scheduled delivery period by an associate of the distributor, such as a scheduled delivery to the particular store or within the geographic region generally. The computer system can then generate a prompt to deliver a quantity of units of a particular product—assigned to a particular slot in the store designated for management by the distributor—corresponding to a difference between a predicted future quantity of units of the first particular product in the particular slot at the third time and an external target stock condition of the particular slot (e.g., specified in an external planogram defined by the external entity or distributor). The computer system can repeat this process for other slots in the store assigned to the distributor for management and then serve these prompts in aggregate to the distributor, such as in the form of a manifest of products to deliver to the store during this next scheduled delivery to the store.

Additionally or alternatively, the computer system can calculate a slot value for each of these distributor-managed slots in the store, such as: proportional to the margin associated with the product assigned to this slot, the historical sale rate of product from the slot, and the difference between the current stock state of the slot and the target stock state of the slot, as specified in the planogram; and inversely proportional to a time that the slot is predicted to remain in an out-of-stock condition. The computer system can then calculate a restock score for the store in aggregate, such as proportional to a quantity of distributor-managed slots in the store and weighted by values of these slots.

As described above, the computer system can rank these stores by their restock scores and selectively dispatch the distributor associate to restock these stores accordingly. The computer system can also implement a cost function to select a subset of stores in the geographic region and/or a subset of distributor-managed slots in these stores to restock during a scheduled future restocking period by the distributor, such as to: achieve a target proportion of the volume of the delivery truck (e.g., 98%) filled with products for restocking at these stores; minimize a total distance traversed or time traveled by the delivery truck during this delivery period; maximize aggregate value of slots returned to their target stock conditions during this delivery period; and/or minimize a duration of time that slots managed by the distributor spend in an out-of-stock or understocked state leading up to and after the delivery period.

The computer system can then implement methods and techniques described above to: generate a delivery route from the distributor to each store containing a slot in this subset of slots; tag each store location along this route with a set of product identifiers and quantities for restocking at the corresponding store; aggregate a manifest of all product identifiers and quantities for restocking across this subset of slots during this delivery; and write these data to the next scheduled delivery period for the distributor (or for a particular distributor associate).

The computer system can therefore account for a delay between receipt of a restocking prompt for the store by the distributor associate and the distributor associate's arrival at the store by responding to trends in sales of products from these slots rather than relying (solely) on real-time out-of-stock and understocked conditions of these slots in these stores. However, the computer system can dispatch a distributor associate to one or a series of stores responsive to any other stock conditions of slots—in these stores—managed by the distributor.

### 12. STOCK STATE VERIFICATION

In one variation, prior to departure of a distributor associate to a store to restock understocked and out-of-stock distributor-managed slots in a store, the computer system can: dispatch a robotic system deployed in the store to scan these distributor-managed slots specifically (or the store in its entirety) during a next scan cycle; derive a current stock condition of these distributor-managed slots in the store based on scan data recorded by this robotic system during this next scan cycle; verify stock states of these distributor-managed slots; and then update a manifest of products for loading into a truck and delivery to the store during this next delivery period based on current stock states of these distributor-managed slots.

For example, when the computer system first prompts the distributor to restock a slot at a store, the computer system can insert an identifier of this store and an order for units of the product assigned to this slot into a scheduled future delivery to the store. Then, at a later time nearing scheduled departure of a distributor associate to the store, the computer system can: dispatch a robotic system in this store to autonomously scan a inventory structure containing out-of-stock and understocked slots assigned to the distributor; access scan data recorded by the first robotic system during this scan cycle; deriving a current stock condition of this inventory structure based on scan data recorded by the first robotic system during this scan cycle; detect current deviations between states of slots in this inventory structure and external target stock conditions of slots in this inventory structure (e.g., specified in an external planogram defined by the distributor or external entity) based on the current stock condition of the inventory structure; and then update quantities of products designated for delivery to this store during the upcoming delivery period based on these updated stock deviations.

### 13. RESTOCKING

Block S140 of the method S100 recites, based on the current stock condition of the store, calculating a route through locations of each understocked slot in the particular subset of slots in the particular store; and Block S142 of the method S100 recites serving the route to a computing device affiliated with the distributor associate. Generally, when the distributor associate arrives at a store—on the list of stores prioritized by the computer system based on current and/or predicted future out-of-stock or understocked slots that are the distributor's responsibility to maintain in the store—the computer system can serve targeted, store-specific guidance to the distributor associate to enable the distributor associate to efficiently restock these slots in the store in Blocks S140 and S142.

In one implementation, when a mobile computing device affiliated with the distributor associate is detected within a geofenced boundary around a store on the ranked list of stores previously calculated by the computer system, or when the associate manually confirms arrival at the store, the computer system retrieves a newest realogram of the store (or other current form of the current stock condition of the store) and finalizes a slot restock list of out-of-stock and understocked slots for restocking by the distributor associate. For example, the computer system can: generate a list of product types (e.g., product SKUs, brand and product names, product descriptions) allocated to out-of-stock or understocked slots that are the distributor's responsibility to maintain in this store; calculate a total quantity of each product type currently absent from its corresponding slot(s) in the store based on differences between the current realogram and the planogram of the store; and append the list of product types with these quantities, plus a buffer (e.g., 5%) in order to account for possible product sales since the last scan of the store by fixed and/or mobile sensors in the store.

The computer system then: defines a restock waypoint—such as in a coordinate system defined within the store—adjacent the location of each slot indicated in the slot restock list based on locations of these slots recorded in the planogram or current realogram of the store; and then calculate a store route from an entrance of the store, through these restock waypoints, and up to an exit of the store. For example, the computer system can implement a cost function to calculate a store route that: intersects at least one restock waypoint adjacent a known location of each slot in the slot restock list; minimizes a length of the store route; and/or minimizes an estimated duration of time to complete the store route by avoiding crowded or obstructed aisles, such as based on a current occupancy distribution and/or locations of spill in the store, as derived from scan data recently collected by fixed and/or mobile sensors in the store.

The computer system can then serve this store route and the list of product types and product quantities to the distributor associate's mobile computing device, such as in the form of an annotated map of the interior of the store.

Furthermore, the computer system can serve this list of product types and product quantities to the associate in reverse order of corresponding restock waypoints along the store route; and the distributor associate can load product from the delivery into a cart or dolly in this reverse order. In particular, by loading products from the delivery vehicle into the cart in this reverse order and then navigating to each restock waypoint along the store route in forward order, product units needed to fill slots at each subsequent restock waypoint along the store route may be placed at the top of the cart and thus: reduce manual redistribution of these product units in the cart by the distributor associate; reduce physical exertion and lifting by the distributor associate; reduce the duration of time that the distributor associate spends restocking these slots; and thus enable the associate to restock more stores within the geographic region with less effort per unit of time.

### 14. MANUAL OBSERVATION

In one variation, the computer system also queries the planogram for each location of a product associated with the distributor (or with the brand, the consumer product company) within a store, such as including: lower, middle, and upper shelves in aisles; promotional displays; and endcaps throughout the store. When generating a store route within the store in preparation for the distributor associate to restock assigned slots in the store, the computer system can also define an observation waypoint at each of these other product locations associated with the distributor and then calculate the store route through both observation waypoints and restock waypoints described above. The computer system can then prompt the distributor associate to restock slots at the restock waypoints and to verify products at observation waypoints while traversing the store route. For example, the computer system can prompt the distributor associate to verify whether products proximal these observation waypoints are tidy, well-lit, visible to shoppers, and reasonably accessible for shoppers in the store. Similarly, for a product associated with the distributor and contracted for placement in an endcap in the store, the computer system can: generate the store route through an observation waypoint adjacent this endcap; serve rules or conditions for display of this product in the endcap; and prompt the distributor associate to verify that these rules are met upon arrival at this endcap.

### 15. AUTONOMOUS ENDCAP MONITORING

The computer system can additionally or alternatively monitor an endcap—designated for a product associated with the distributor—remotely to verify that rules or conditions for display of this product in the endcap are fulfilled. For example, the computer system can implement computer vision and/or artificial intelligence techniques—such as described above and in U.S. patent application Ser. No. 15/600,527—to identify each product unit and the position and orientation of these product units on the end cap from scan data recorded by the robotic system during a last scan cycle in the store. The computer system can then compare these product unit identities, locations, and orientations to the planogram (and to rules or conditions for the endcap recorded in the planogram) and verify or flag the endcap accordingly. For example, the computer system can flag the endcap if a second product is detected in the endcap but the rules and conditions for the endcap specify that no other product from another brand may be present in the endcap. Upon identifying deviation of such rules or conditions at the endcap, the computer system can: serve a prompt to a manager associated with the distributor to manage the endcap and the store remotely; or serve a prompt to a distributor associate to manage the endcap upon her next restocking cycle at the store.

The computer system can implement similar methods and techniques to selectively prompt the distributor manager and/or the distributor associate to manage products on contracted or designated slots throughout store, such as to verify that a product designated for a specific shelf (e.g., a middle shelf of an shelving structure) is not located on incorrect shelf (e.g., a bottom or top self of the shelving structure). Furthermore, the computer system can implement similar methods and techniques to monitor freestanding promotional displays throughout the store and to selectively prompt the distributor manager and/or the distributor associate to manage products designated for these promotional displays.

### 16. REMOTE SUPPORT

In one variation, rather than dispatch a distributor associate and a delivery vehicle stocked with product to a store to restock a slot assigned to management by the distributor, the computer system selectively prompts a store associate or other entities with more immediate access to the store.

For example, rather than dispatch the distributor associate to the store when the computer system detects that one or a small number of slots—designated for management by the distributor—are currently out-of-stock or understocked in the store, the computer system serves a prompt to the store manager or to a store associate to restock the slot(s) with product stationed in the back of the store by the distributor associate during a previous delivery to the store. Therefore, in this example, the computer system can determine that the cost to dispatch the distributor associate to the store to restock this small number of out-of-stock and/or understocked slots exceeds an estimated value of these slots being fully stocked (e.g., if the delivery truck is far away from the store or is not currently available or if higher restock scores have been calculated for other stores in the geographic region); and the computer system can coordinate with store managers, store associates, or a third-party entities near or in the store to restock this small number of slots with product available in the back of the store. (The computer system can also: estimate a total cost for the distributor to return to the store to restock this slot(s); and manage distribution of a fraction of this cost to the store, the store manager, the store associate, or the third-party entity as compensation for this restocking action.)

### 17. METRICS AND REPORTING

In another variation shown in FIGS. 2 and 4, the computer system generates a statement of product presence, out-of-stock conditions, and understock conditions for slots assigned to or contracted by the distributor (or the external entity) and returns this statement to the distributor (or external entity) in Block S150. In particular, based on a realogram generated from data collected by the robotic system during a recent scan cycle, the computer system can track a proportion of slots (or product facings) in the store managed by a distributor or containing products by a particular consumer goods company, such as relative to a total number of slots: in the store as a whole; assigned to a competitor of the consumer goods company; or managed by another local distributor. The computer system can similarly track a “share of shelf” metric for products managed by the distributor or for products supplied by the consumer goods company, such as by counting a number of pixels—in a recent image of a shelving structure recorded by the robotic system—corresponding to the distributor's or consumer goods company's products relative to pixels corresponding to all products in this shelving structure or relative to competitor products stocked in this shelving structure. Based on a series of realograms of the store generated over time from data collected by the robotic system throughout a series of scan cycles, the computer system can also quantify a proportion of time that slots managed by the distributor or containing products supplied by the particular consumer goods company are understocked, such as relative to a total number of slots in the store or assigned to a competitor of the consumer goods company. The computer system can serve these metrics to the distributor or to the consumer goods company to inform (re)allocation of products, distributor associates, and/or other resources to stores within a geographic region.

### 17.1 Contract Recommendations

In this variation, the computer system can serve a recommendation to the distributor or consumer goods company to contract allocation of more (or fewer) slots in a store for its products based on stock states of slots in the store—currently assigned to the distributor or consumer goods company—over time. For example, the computer system can implement methods and techniques described above to detect stock conditions of the store over time based on scan data recorded by the robotic system—deployed to the store—over multiple scan cycles. The computer system can also: detect removal (e.g., sales) of units of product from slots in the store based on reduction of units of products detected in slots over successive scan cycles; and similarly detect restocking of slots in the store between two consecutive scan cycles responsive to increases in quantities of units of products in these slots indicated in the corresponding stock conditions derived from scan data recorded during these scan cycles. Furthermore, the computer system can track stock states of individual slots in the store over time based on scan data collected by the robotic system (or other fixed sensors in the store) over multiple scan cycles, such as by generating and storing a timeseries of detected presence of at least one unit of an assigned product and/or detected quantity of units of the assigned product for an individual slot in the store. The computer system can then derive various metrics for an individual slot based on its timeseries of product presence, such as including: an out-of-stock frequency of the assigned product at the slot; a restocking frequency of the assigned product at the slot; a maximum or average understock time of the slot; a maximum or average out-of-stock time of the slot; and/or a maximum or average fully-stocked time of the slot; etc. The computer system can serve these metrics for all distributor-managed slots in the store to the distributor or consumer goods company, such as through the distributor manager portal described above.

Furthermore, in the foregoing implementation, the computer system can serve additional recommendations to the distributor or consumer goods company based on these metrics and timeseries data. For example, if the out-of-stock time of a particular slot in the store exceeds a threshold out-of-stock frequency (e.g., four hours per day) but if a restocking frequency of the particular slot exceeds a threshold restocking frequency (e.g., twice per day), the computer system can serve a recommendation to the distributor or consumer goods company to contract allocation of an additional slot for the particular product at the first store. Conversely, if a particular product is fully or partially stocked for more than a threshold frequency (e.g., 40 hours per two-day interval) but if the restocking frequency of this slot is less than a low restocking frequency (e.g., once per four-day interval), the computer system can serve a recommendation to the distributor or consumer goods company to assign an alternate product to this slot or to cease a contract for the store with the store.

### 17.2 Photographic Images

In another implementation, the computer system returns photographic images of slots or other inventory structures contracted by the distributor or external entity. However, because data depicting other slots and inventory structures throughout the store may be owned by the store and other external entities contracting product placement in the store, the computer system can redact or crop these photographic images to depict only slots and other inventory structures contracted by the corresponding distributor or other external entity before serving these redacted or cropped photographic images to the distributor or external entity.

For example, the robotic system can capture photographic images (e.g., digital color photographic images) of inventory structures throughout the store during a scan cycle. The computer system can then derive a stock condition of the store from these photographic images. Then, in response to detecting deviation from a target stock condition at a particular distributor-managed slot in the store, the computer system can: retrieve a photographic image—from a set of photographic images recorded by the robotic system during its last scan cycle at the store—depicting the inventory structure containing this particular slot; extract a crop region, from the photographic image, depicting the particular slot and other slots assigned to the distributor; annotate the crop region of the particular photographic image to highlight the particular slot; and then serve this crop region to the distributor manager portal, thereby providing the distributor with remote, visual access to its understocked or out-of-stock slots in the store.

Alternatively, the computer system can implement similar methods and techniques to redact or crop a realogram of this inventory structure to depict only slots contracted or assigned for management by the distributor and then serve this redacted or cropped realogram to the distributor (or other external entity).

### 18. VARIATIONS

In one variation, the computer system can interface with the robotic system to repeat the foregoing methods and techniques to rescan the slots throughout the store and to verify that the distributor associate properly restocked slots during her last restocking cycle.

In another variation, the computer system can: reference a database of brand/distributor-sponsored promotions or retail-sponsored promotions (e.g., ‘buy one get one free’ promotions, instant redeemable coupons) against a recent realogram generated from data collected by the robotic system in order to verify whether these promotions are being executed by the store; and then serve flags or notifications to relevant parties responsive to detecting deviations (e.g., time, location, and/or magnitude deviations) from such promotions in the store.

In yet another variation, the computer system can: implement methods and techniques described above and in U.S. patent application Ser. No. 15/600,527 to identify a product supplied by a particular distributor or associated with a particular consumer goods company that is discontinued or expired; and selectively serve notifications or flags to the corresponding distributor or consumer goods company responsive to detecting such this product, such as including a prompt to remove the product from the store during a next restock cycle.

The computer systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for managing stock within stores comprising:
at a first time, dispatching a first robotic system, deployed in a first store, to autonomously scan inventory structures within the first store during a first scan cycle;
accessing scan data recorded by the first robotic system during the first scan cycle;
deriving a first stock condition of the first store at approximately the first time based on scan data recorded by the first robotic system during the first scan cycle;
based on the first stock condition of the first store, detecting a first deviation between a first state of a first slot in a first inventory structure in the first store at approximately the first time and a first internal target stock condition of the first slot defined by an affiliate of the first store;
in response to detecting the first deviation, serving a first prompt to restock the first slot to an associate of the first store;
based on the first stock condition of the first store, detecting a second deviation between a second state of a second slot in a second inventory structure in the first store at approximately the first time and an external target stock condition of the second slot defined by an entity external to the first store and affiliated with a second product assigned to the second slot; and
in response to detecting the second deviation, serving a second prompt to restock the second slot to a distributor external to the first store.

2. The method of claim 1:
wherein deriving the first stock condition of the first store comprises, based on scan data recorded by the first robotic system during the first scan cycle:
detecting presence of a first quantity of units of a first product on the first inventory structure; and
detecting absence of units of the second product on the second inventory structure; and
wherein detecting the first deviation comprises:
accessing an internal planogram defined by the affiliate of the first store and defining internal target stock conditions of a first subset of slots in the first store, the first subset of slots comprising the first slot; and
in response to the first internal target stock condition of the first slot, defined by the internal planogram, specifying a first target quantity of units of the first product on the first inventory structure exceeding the first quantity of units of the first product, detecting the first deviation;
wherein serving the first prompt to restock the first slot comprises serving the first prompt, to restock the first slot with a difference between the first target quantity of units and the first quantity of units of the first product, to the associate of the first store;
wherein detecting the second deviation comprises:
accessing a contract planogram defined by the entity external to the first store, contracted between the entity and the first store, and defining external target stock conditions for the second inventory structure; and
in response to the contract planogram specifying a second target quantity of units of the second product on the second inventory structure and, in response to absence of units of the second product on the second inventory structure, detecting the second deviation; and
wherein serving the first prompt to restock the first slot comprises:
generating the second prompt to restock the second slot at the first store with the target quantity of units of the second product and to deliver an excess quantity of units of the second product for inventory to the first store; and
serving the second prompt to the distributor.

3. The method of claim 1:
wherein deriving the first stock condition of the first store comprises, based on scan data recorded by the first robotic system during the first scan cycle:
detecting presence of a first quantity of units of a first product on the first inventory structure; and
detecting locations of units of the second product on the second inventory structure; and
wherein detecting the first deviation comprises:
accessing an internal planogram defined by the affiliate of the first store and defining internal target stock conditions of a first subset of slots in the first store, the first subset of slots comprising the first slot; and
in response to the first internal target stock condition of the first slot, defined by the internal planogram, specifying a first target quantity of units of the first product on the first inventory structure exceeding the first quantity of units of the first product, detecting the first deviation;
wherein serving the first prompt to restock the first slot comprises serving the first prompt, to restock the first slot with a difference between the first target quantity of units and the first quantity of units of the first product, to the associate of the first store; and
wherein detecting the second deviation comprises:
accessing a contract planogram defined by the entity external to the first store, contracted between the entity and the first store, and defining external target stock conditions for the second inventory structure; and
in response to the contract planogram specifying a second distribution of units of the second product on the second inventory structure different from locations of units of the second product on the second inventory structure, detecting the second deviation.

4. The method of claim 3:
further comprising, in response to detecting the second deviation, serving an intermediate prompt to the associate of the first store to organize the first inventory structure according to the contract planogram at an intermediate time succeeding the first time; and
wherein serving the second prompt to restock the second slot to the distributor comprises serving the second prompt to restock the second slot to the distributor at a second time succeeding the intermediate time.

5. The method of claim 1:
wherein serving the first prompt to restock the first slot to the associate of the first store comprises:
inserting the first prompt to restock the first slot into a global electronic restocking list for the first store; and
serving the global electronic restocking list to a mobile device associated with the associate during a scheduled restocking period in the first store; and
wherein serving the second prompt to restock the second slot to the distributor comprises inserting an identifier of the first store and an order for units of the second product into a next scheduled delivery from the distributor to stores in a geographic region containing the first store.

6. The method of claim 1:
wherein serving the second prompt to restock the second slot to the distributor comprises inserting an identifier of the first store and an order for units of the second product into a scheduled delivery to the first store during a third time period succeeding the first time;
further comprising:
at a second time between the first time and the third time period, dispatching the first robotic system to autonomously scan the second inventory structure during a second scan cycle; and
accessing scan data recorded by the first robotic system during the second scan cycle;
deriving a second stock condition of the second inventory structure in the first store at approximately the second time based on scan data recorded by the first robotic system during the second scan cycle;
based on the second stock condition of the second inventory structure in the first store, detecting a second set of deviations between states of slots in the second inventory structure in the first store at approximately the second time and external target stock conditions of slots in the second inventory structure defined by the entity; and
prior to the third time period, updating products designated for delivery to the first store during the scheduled delivery to the first store based on the second set of deviations.

7. The method of claim 1, further comprising:
based on the first stock condition of the first store, detecting a third deviation between a third state of a third slot in a third inventory structure in the first store at approximately the first time and a third external target stock condition of the third slot defined by a second entity external to the first store and affiliated with a third product assigned to the third slot; and
in response to detecting the third deviation and in response to designation of the third slot for management by the first store:
serving a third prompt to restock the third slot to the first store associate; and
storing the third state of the third slot for access by the second entity.

8. The method of claim 1:
further comprising:
for each store in a set of stores within a geographic region and comprising the first store:
dispatching a robotic system, deployed in the store, to autonomously scan shelving structures within the store;
deriving a current stock condition of the store based on scan data recorded by the robotic system; and
based on a difference between the current stock condition and a planogram of the store, identifying a subset of understocked slots in the store designated for management by the distributor; and
ranking stores, in the set of stores, based on values of subsets of understocked slots in the set of stores; and
wherein serving the second prompt to restock the second slot to the distributor comprises dispatching a distributor associate to the first store to restock a first subset of understocked slots in the first store in response to a first rank of the first store exceeding a second rank of a second store in the set of stores, the first subset of understocked slots comprising the second slot.

9. The method of claim 8, further comprising:
based on the first stock condition of the first store at approximately the first time, calculating a first route through locations of slots in the first subset of slots in the first store; and
serving the first route to a computing device affiliated with the distributor associate.

10. The method of claim 8, wherein ranking stores, in the set of stores, comprises:
for each store in the set of stores:
for each slot in the subset of understocked slots in the store:
detecting a quantity of units of a product, assigned to the slot, absent from the slot based on a planogram of the store;
accessing a margin of the product assigned to the slot; and
calculating a value of the slot based on a combination of the quantity of units of the product and the margin of the product for the distributor; and
calculating an aggregate update value for the store based on a combination of values of slots in the subset of understocked slots, in the store, designated for management by the distributor; and
ranking stores, in the set of stores, based on aggregate update values for stored within the geographic region.

11. The method of claim 1:
further comprising:
for each store in a set of stores within a geographic region, the set of stores comprising the first store:
dispatching a robotic system, deployed in the store, to autonomously scan shelving structures within the store;
deriving a current stock condition of the store based on scan data recorded by the robotic system; and
based on a difference between the current stock condition and a planogram of the store, identifying a subset of understocked slots in the store designated for management by the distributor; and
calculating an aggregate volume of products absent from slots, designated for management by the distributor, in the set of stores; and
wherein serving the second prompt to restock the second slot to the distributor comprises, in response to the aggregate volume of products exceeding a threshold volume:
dispatching a distributor associate to the set of stores to restock slots, designated for management by the distributor, in the set of stores; and
prompt the distributor associate to restock the second slot in the first store, in the set of stores.

12. The method of claim 1:
further comprising, at the first robotic system deployed in the first store:
autonomously navigating along a set of aisles within the first store during the first scan cycle; and
while autonomously navigating along a particular aisle in the set of aisles, recording a set of digital images of a set of inventory structures facing the particular aisle;
wherein accessing scan data recorded by the first robotic system during the first scan cycle comprises accessing the set of digital images; and
wherein deriving the first stock condition of the first store at approximately the first time and detecting the first deviation comprises:
detecting a first shelf in a first inventory structure in a first region of a first digital image in the set of digital images, the first shelf comprising the first slot;
identifying an address of the first shelf;
based on the address of the first shelf, retrieving a first list of products assigned to the first shelf by a planogram of the first store, the planogram defined by the affiliate of the first store;
retrieving a first set of template images from a database of template images, each template image in the first set of template images comprising features of a product in the first list of products;
extracting a first set of features from the first region of the first digital image; and
detecting absence of the first product on the first shelf based on misalignment between features in the first set of features and features in a first template image, in the first set of template images, corresponding to the first product.

13. The method of claim 1:
further comprising, at the first robotic system deployed in the first store:
autonomously navigating along a set of aisles within the first store during the first scan cycle; and
while autonomously navigating along a particular aisle in the set of aisles, recording a set of digital images of a set of inventory structures facing the particular aisle;
wherein accessing scan data recorded by the first robotic system during the first scan cycle comprises accessing the set of digital images;
wherein deriving the first stock condition of the first store at approximately the first time comprises:
detecting a first shelf in a first inventory structure in a first region of a first digital image in the set of digital images, the first shelf comprising the second slot;
identifying an address of the first shelf;
based on the address of the first shelf, retrieving a first list of products assigned to the first shelf by the entity;
retrieving a first set of template images from a database of template images, each template image in the first set of template images comprising features of a product in the first list of products;
extracting a first set of features from the first region of the first digital image;
detecting presence of a unit of the second product on the first shelf based on alignment between features in the first set of features and features in a second template image, in the first set of template images, corresponding to the second product; and
wherein detecting the second deviation comprises identifying the unit of the second product as out-of-date; and
wherein serving the second prompt to restock the second slot to the distributor comprises serving the second prompt, to the distributor, to retrieve the unit of the second product and to restock the second slot with current units of the second product.

14. The method of claim 1:
wherein accessing scan data recorded by the first robotic system during the first scan cycle comprises accessing a set of photographic images recorded by the first robotic system during the first scan cycle;
wherein deriving the first stock condition of the first store at approximately the first time comprises detecting units of products in the set of photographic images; and
further comprising, in response to detecting the second deviation:
retrieving a second photographic image, in the set of photographic images, depicting the second inventory structure;
extracting a crop region, depicting a set of slots designated for management by the entity, from the second photographic image; and
serving the crop region to the entity.

15. The method of claim 1:
further comprising:
at an initial time preceding the first time, dispatching the first robotic system to autonomously scan inventory structures within the first store during an initial scan cycle;
accessing scan data recorded by the first robotic system during the initial scan cycle;
deriving an initial stock condition of the first store at approximately the initial time based on scan data recorded by the first robotic system during the initial scan cycle;
extrapolating a third state of the second slot at a second time succeeding the first time based on a difference between an initial state of the second slot at approximately the initial time and the second state of the second slot at approximately the second time; and
wherein serving the second prompt to restock the second slot to the distributor comprises prompting the distributor to deliver a quantity of units of the second product to the store at approximately the third time, the quantity corresponding to a difference between the third state of the second slot at a second time and the external target stock condition of the second slot defined by the entity.

16. The method of claim 1, wherein extrapolating the third state of the second slot at the second time succeeding the first time comprises estimating the third state of the second slot at the second time coincident a scheduled delivery period within a geographic region containing the first store.

17. The method of claim 1, further comprising:
at a second time succeeding the first time, dispatching the first robotic system to autonomously scan inventory structures within the first store during an initial scan cycle;
accessing scan data recorded by the first robotic system during the second scan cycle;
deriving a second stock condition of the first store at approximately the initial time based on scan data recorded by the first robotic system during the second scan cycle;
detecting restocking of the second slot between the first time and the second time in response to a second quantity of units of the second product at the second slot indicated in the second stock condition exceeding a first quantity of units of the second product at the second slot indicated in the first stock condition;
deriving an out-of-stock frequency of the second product at the second slot based on the first stock condition and the second stock condition;
deriving a restocking frequency of the second product at the second slot based on the second stock condition; and
in response to the out-of-stock time of the second product exceeding a threshold out-of-stock frequency and in response to the restocking frequency exceeding a threshold restocking frequency, serving a prompt to the entity to contract allocation of an additional slot for the second product at the first store.

18. A method for managing stock within a store comprising:
for each store in a set of stores within a geographic region:
dispatching a robotic system, deployed in the store, to autonomously scan shelving structures within the store during a scan cycle;
deriving a current stock condition of the store based on scan data recorded by the robotic system during the scan cycle; and
based on a difference between the current stock condition and a planogram of the store, identifying a subset of understocked slots in the store designated for management by a distributor external to the store;
ranking stores, in the set of stores, based on values of subsets of understocked slots in the set of stores;
based on a rank of a first store in the set of stores, dispatching a distributor associate to the first store to restock a first subset of understocked slots in the first store;
based on a current stock condition of the first store, calculating a first route through locations of slots in the first subset of slots in the first store; and
serving the first route to a computing device affiliated with the distributor associate.

19. The method of claim 18, wherein ranking stores, in the set of stores, based on values of subsets of understocked slots in the set of stores comprises:
for each store in the set of stores:
for each slot in the subset of understocked slots in the store:
detecting a quantity of units of a product, assigned to the slot, absent from the slot based on a planogram of the store;
accessing a margin of the product assigned to the slot; and
calculating a value of the slot based on a combination of the quantity of units of the product and the margin of the product assigned to the slot; and
calculating a restock score for the store based on a combination of values of slots in the subset of understocked slots, in the store, designated for management by the distributor; and
ranking stores, in the set of stores, based on aggregate update values.

20. The method of claim 18:
further comprising, at the first robotic system deployed in the first store:
autonomously navigating along a set of aisles within the first store during a first scan cycle; and
while autonomously navigating within a particular aisle in the set of aisles, recording a first set of digital images of a set of inventory structures facing the particular aisle during the first scan cycle; and
wherein deriving a current stock condition of a store in the set of stores comprises:
detecting a first shelf in a first inventory structure in a first region of a first digital image in the first set of digital images;
identifying an address of the first shelf;
based on the address of the first shelf, retrieving a first list of products assigned to the first shelf by the entity;
retrieving a first set of template images from a database of template images, each template image in the first set of template images comprising features of a product in the first list of products;
extracting a first set of features from the first region of the first digital image; and
detecting absence of a first product on the first shelf based on misalignment between features in the first set of features and features in a first template image, in the first set of template images, corresponding to the first product, the first product assigned to the first shelf by a current planogram of the first store.

21. A method for managing stock within stores comprising:
at a first time, dispatching a first robotic system, deployed in a first store, to autonomously scan inventory structures within the first store during a first scan cycle;
accessing scan data recorded by the first robotic system during the first scan cycle;
deriving a first stock condition of the first store at approximately the first time based on scan data recorded by the first robotic system during the first scan cycle;
based on the first stock condition of the first store, detecting a first deviation between a first state of a first slot in a first inventory structure in the first store at approximately the first time and a first internal target stock condition of the first slot defined by an affiliate of the first store;
in response to detecting the first deviation, serving a first prompt to restock the first slot to an associate of the first store;
based on the first stock condition of the first store, detecting a second deviation between a second state of a second slot in a second inventory structure in the first store at approximately the first time and an external target stock condition of the second slot defined by an entity external to the first store and affiliated with a second product assigned to the second slot;
at a second time, dispatching a second robotic system to autonomously scan inventory structures within the first store during a second scan cycle;
accessing scan data recorded by the first robotic system during the second scan cycle;
deriving a second stock condition of the first store at approximately the second time based on scan data recorded by the first robotic system during the second scan cycle;
based on the second stock condition of the first store, detecting a third deviation between a second state of the second slot at approximately the second time and the external target stock condition of the second slot;
generating a statement of stock states of the second slot based on the second deviation and the third deviation; and
returning the statement to the entity.
